(19) United States
(12) Patent Application Publication
(10) Pub. No.: US 2018/0015826 A1
(43) Pub. Date: Jan. 18, 2018

(54) Vehicle Interior Lighting Systems And Methods

(71) Applicant: Ford Global Technologies, LLC, Dearborn, MI (US)

(72) Inventors: Mohamed Ahmad, Mountain View, CA (US); Alexander Groh, Detroit, MI (US); Surjya Sarathi Ray, San Jose, CA (US); Jennifer L. Brace, Sunnyvale, CA (US)

(21) Appl. No.: 15/210,594

(22) Filed: Jul. 14, 2016

(51) Int. Cl. B60K 28/06; B60K 35/00; B60Q 5/00; B60Q 9/00

(52) U.S. Cl. CPC B60K 28/066; B60Q 9/00; B60K 35/00; B60Q 5/005

(57) ABSTRACT

Techniques pertaining to user notification via interior lighting for improved human-machine interface in vehicles are described. A method may involve a notification system of a vehicle receiving one or more signals each indicating a respective level of a plurality of levels of required user involvement required in operation of the vehicle. The method may also involve the notification system providing a visual notification with at least one aspect of the visual notification corresponding to the respective level of required user involvement indicated by each signal of the one or more signals.

### TECHNICAL FIELD

The present disclosure generally relates to user interface in vehicles and, more particularly, to user notification via interior lighting for improved human-machine interface in vehicles.

### BACKGROUND

Various driver assistance systems have been developed to enhance and/or automate the driving process for safety and improved user experience. Some examples of driver assistance include adaptive cruise control, adaptive high beam, automotive navigation, blind spot monitoring, collision avoidance, collision warning, parking assistance, turning assistance and the like. However, certain aspects of human-machine interface associated with driver assistance are not yet well defined. For instance, how a driver assistance system of a vehicle communicates to a user (e.g., the driver of the vehicle) about whether the driver can take his/her hands off the steering wheel is not well defined.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram depicting an example scenario in which embodiments in accordance with the present disclosure may be utilized.

FIG. 2 is a diagram depicting an example vehicle in which embodiments in accordance with the present disclosure may be utilized.

FIG. 3 is a simplified block diagram depicting an example apparatus in accordance with an embodiment of the present disclosure.

FIG. 4 is a flowchart depicting an example process in accordance with an embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

As features of driver assistance are developed and implemented, some driving situations may not require a human driver to control or otherwise operate the vehicle while other driving situations may require input and/or control of the steering wheel from the human driver. The present disclosure provides a system that indicates to a vehicle driver when it is safe or not safe for the driver to take his/her hands off the steering wheel. The system may include a light-emitting diode (LED) wire installed in or on the steering wheel that indicates whether it is safe or not safe for the driver to take his/her hands off the steering wheel. For instance, the LED wire may change color to indicate a level of required user involvement in operation of the vehicle. Intensity of the light emitted by the LED wire may change as time passes if the driver has not taken control of the steering wheel when manual control by the driver is required.

In addition to the LED wire, system may display a message in a display device to indicate the level of required user involvement in operation of the vehicle. The message may, for example, indicate that vehicle control is being relinquished to the driver. The system may also provide an auditory signal to notify the driver that manual control of the steering wheel by the driver is required or that vehicle control is being relinquished to the driver. The system may further control the color of an ambient lighting inside the vehicle to match that of the LED wire color to better draw the attention of the human driver.

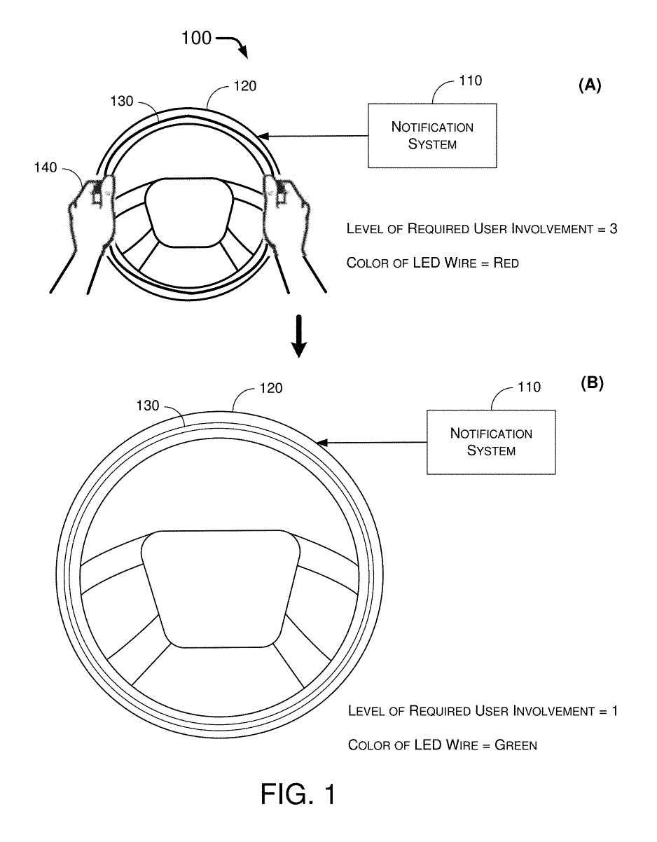

FIG. 1 illustrates an example scenario 100 in which embodiments in accordance with the present disclosure may be utilized. Scenario 100 may involve a notification system 110, which is implemented in a vehicle, controlling at least one notification device 130 to indicate to a driver of the vehicle a level of required user involvement in operation of the vehicle. That is, notification system 110 may control the at least one notification device 130 to indicate to the driver when it is safe or not safe for the driver to take his/her hands 140 off a steering wheel 120 of the vehicle. Notification system 110 may receive one or more signals from one or more components, devices and/or sensors of the vehicle (not shown), and each of the received signal may indicate a respective level of multiple levels of required user involvement in operation of the vehicle.

In the context of visual notification, notification system 110 may control the at least one notification device 130, e.g., an LED wire and/or light source(s), to change color to indicate a level of required user involvement in operation of the vehicle. Each color of light emitted by the at least one notification device 130 may correspond to a respective level of required user involvement in operation of the vehicle. As an example, for illustrative purposes and without limiting the scope of the present disclosure, a green light may indicate a low level of required user involvement (e.g., level=1, meaning the driver can take his/her hands off of steering wheel 120), an orange light may indicate a medium level of required user involvement (e.g., level=2, meaning the driver should take control of steering wheel 120), and a red light may indicate a high level of required user involvement (e.g., level=3, meaning manual control of steering wheel 120 by the driver is necessary for safety concerns). Moreover, notification system 110 may change an intensity of the light emitted by the at least one notification device 130 as time passes if the driver has not taken control of the steering wheel when manual control by the driver is required.

In the example shown in FIG. 1, the at least one notification device 130 includes an LED wire installed on or in steering wheel 120. The visible portion of the LED wire may be circular and looping around steering wheel 120, as shown in FIG. 1. Alternatively, the visible portion of the LED wire may be in a different shape or configuration such as, for example and not limited to, semi-circular, curving and/or multi-segmental in shape.

Part (A) of scenario 100 illustrates a condition in which the level of required user involvement is high (e.g., level=3). Accordingly, the at least one notification device 130 in the form of an LED wire emits light in a corresponding color (e.g., color=red), and steering wheel 120 is held and controlled by the hands 140 of the driver. Part (B) of scenario 100 illustrates a condition in which the level of required user involvement is low (e.g., level=1). Accordingly, the at least one notification device 130 in the form of an LED wire emits light in a corresponding color (e.g., color=green), and the hands 140 of the driver are off of steering wheel 120 (e.g., with the vehicle being in an auto-pilot mode).

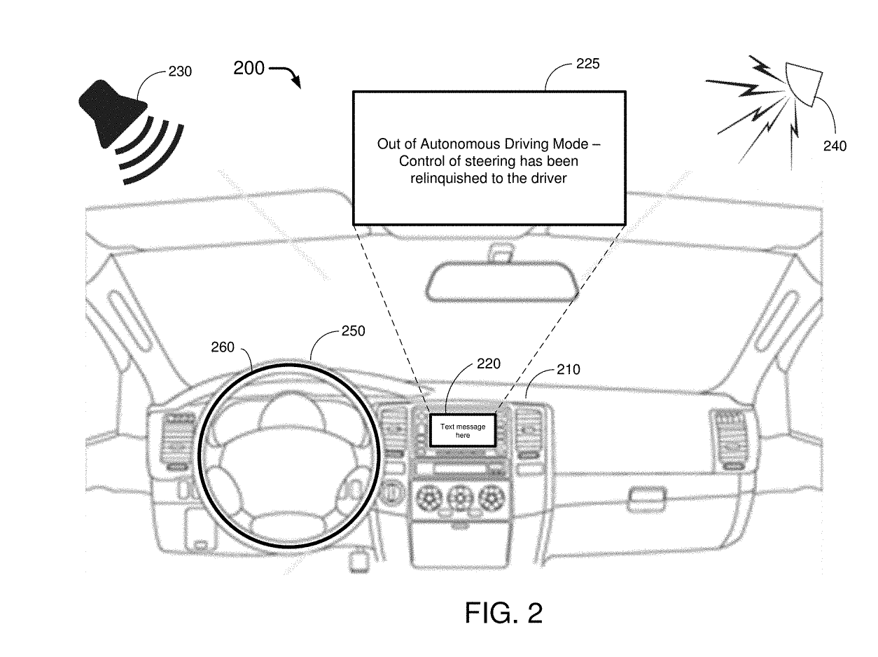

FIG. 2 illustrates an example vehicle 200 in which embodiments in accordance with the present disclosure may be utilized. As scenario 100 may be implemented in vehicle 200, description above with respect to scenario 100 may apply to vehicle 200. Vehicle 200 may include a dashboard 210 having a display device 220 installed therein. Vehicle 200 may include a steering wheel 250 having an LED wire 260 installed in or on steering wheel 250. For example, LED wire 260 may be embedded in steering wheel 250 and thus may be flush with a surface of steering wheel 250. Alternatively, LED wire 260 may be disposed on the surface of steering wheel 250 and thus may protrude from the surface of steering wheel 250. Display device 220 may include a flat panel display (e.g., a liquid crystal display panel, an electroluminescent panel or an organic LED display panel) and/or a touch-sensing display. For ease of viewing, an enlarged view 225 of an example content being displayed by display device 220 is provided in FIG. 2. In the example shown in FIG. 2, a text message is displayed by display device 220.

Vehicle 200 may also provide one or more auditory signals 230 and/or one or more visual signals 240 to the driver of vehicle 200 in addition to the visual notification provided by LED wire 260 and display device 220. The one or more auditory signals 230 may include a steady tone, a beeping tone, a pre-recorded human voice, a computer-synthesized human voice, or any combination thereof. The one or more visual signals 240 may include one or more steady lights of one or more colors, one or more flashing or blinking lights of one or more colors, or any combination thereof. Vehicle 200 may determine a level of required user involvement for the operation of vehicle 200, and may correspondingly vary one or more aspects of LED wire 260, one or more aspects of the content displayed by display device 220, one or more aspects of the one or more auditory signals 230 and/or one or more aspects of the one or more visual signals 240 accordingly. For visual notifications, the one or more aspects of the one or more visual signals 240 may include, for example and not limited to, a color of the emitted light, an intensity of the emitted light, a frequency of flashing or blinking of the emitted light, or any combination thereof. Similarly, the one or more aspects of the content displayed by display device 220 may include, for example and not limited to, a message in the content being displayed, a color of the content, a brightness of the content, or any combination thereof. For auditory notifications, the one or more aspects of the one or more auditory signals 230 may include, for example and not limited to, a tone of the emitted sound, a volume of the emitted sound, a pitch of the emitted sound, or any combination thereof

For instance, vehicle 200 may vary one or more of a color, an intensity, and a frequency of LED wire 260 to indicate that the level of required user involvement is increasing (e.g., changing color of light emitted by LED wire 260 from yellow to orange to red, increasing intensity of the light and/or increasing frequency of the light) or decreasing (e.g., changing color of light emitted by LED wire 260 from red to orange to yellow, decreasing intensity of the light and/or decreasing frequency of the light). Moreover, vehicle 200 may vary one or more of a tone, a frequency, and a volume of the one or more auditory signals 230 to indicate that the level of required user involvement is increasing (e.g., increasing tone, increasing frequency and/or increasing volume) or decreasing (e.g., decreasing tone, decreasing frequency and/or decreasing volume). Additionally or alternatively, vehicle 200 may vary one or more of a color, an intensity, and a frequency of the one or more visual signals 240 to indicate that the level of required user involvement is increasing (e.g., changing color of one or more lights from yellow to orange to red, increasing intensity and/or increasing frequency) or decreasing (e.g., changing color of one or more lights from red to orange to yellow, decreasing intensity and/or decreasing frequency).

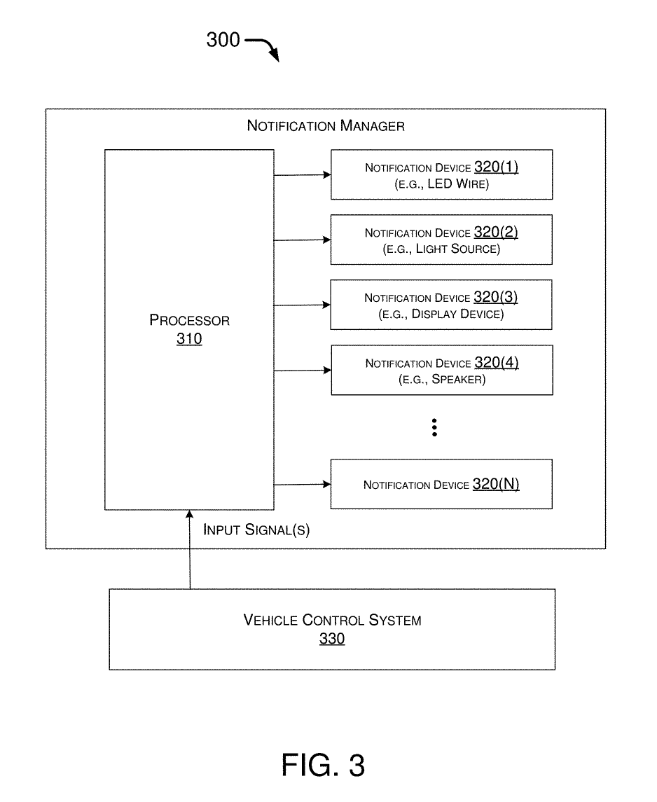

FIG. 3 illustrates an example apparatus, or notification manager 300, in accordance with an embodiment of the present disclosure. Notification manager 300 may perform various functions related to techniques, methods and systems described herein, including those described above with respect to scenario 100 and vehicle 200 as well as those described below with respect to process 400. Notification manager 300 may be installed, equipped or otherwise implemented in scenario 100 and vehicle 200 to effect various embodiments in accordance with the present disclosure. Notification manager 300 may be an example implementation of notification system 110. Notification manager 300 may include at least some of the components illustrated in FIG. 3.

Notification manager 300 may include at least one notification device. For the purpose of description, the at least one notification device is shown as one or more notification devices 320(1)-320(N) in FIG. 3 with N being a positive integer greater than or equal to 1. Each of the one or more notification devices 320(1)-320(N) may be configured to provide a human-perceivable notification, in either or both of a visual manner and an auditory manner, as a notification to a user (e.g., driver) of a vehicle. For instance, in terms of providing a notification in a visual manner, the one or more notification devices 320(1)-320(N) may be configured to provide a steady light, a flashing or blinking light, a display of textual information, a display of graphical information and/or a display of video information. In terms of providing a notification in an auditory manner, the one or more notification devices 320(1)-320(N) may be configured to provide a steady tone, a beeping tone, a pre-recorded human voice and/or a computer-synthesized human voice.

In some embodiments, the one or more notification devices 320(1)-320(N) may include an LED wire installed in or on a steering wheel of the vehicle. In some embodiments, the one or more notification devices 320(1)-320(N) may include at least one additional light source installed in or on the steering wheel, a display panel, a dashboard, a center console, a door panel, a cup holder, a door handle, a windshield, an overhead ceiling, or a visor of the vehicle. Additionally or alternatively, the one or more notification devices 320(1)-320(N) may include at least one speaker configured to provide an auditory signal. Additionally or alternatively, the one or more notification devices 320(1)-320(N) may include at least one display device configured to display textual information, graphical information, audio information, video information, or any combination thereof. For illustrative purposed and without limiting the scope of the present disclosure, as shown in FIG. 3, notification device 320(1) may be an LED wire, notification device 320(2) may be a light source, notification device 320(3) may be a display device, and notification device 320(4) may be a speaker.

Notification manager 300 may also include a processor 310 operatively coupled to the one or more notification devices 320(1)-320(N). Processor 310 may be configured to receive one or more signals from one or more components, devices and/or sensors of the vehicle (e.g., a vehicle control system 330), with each of the received signal indicating a respective level of multiple levels of required user involvement in operation of the vehicle. Vehicle control system 330 may include one or more processors and one or more sensors, and may be configured to detect one or more conditions (e.g., road conditions, weather conditions and/or vehicle conditions) to determine a level of required user involvement by the driver of a vehicle for safe control, operation and/or maneuvering of the vehicle under the detected condition(s). That is, depending on the current road condition, weather condition and/or vehicle condition being detected, vehicle control system 330 may provide a signal to indicate the level of required user involvement corresponding to the detected condition(s). Vehicle control system 330 may provide different signal(s) as the detected condition(s) change over time to reflect change(s) in the level of required user involvement corresponding to change(s) in the detected condition(s). In some embodiments, the multiple levels of required user involvement may include a first level at which no user control of a steering wheel of the vehicle is required, a second level at which user control of the steering wheel is needed, and a third level at which the user control is mandatory/required to avoid a danger. For instance, processor 310 may receive a first signal indicating a first level of required user involvement in operation of the vehicle (e.g., that it is safe for the driver to remove his/her hands from the steering wheel), a second signal indicating a second level of required user involvement in operation of the vehicle (e.g., that the driver should take control of the steering wheel) as well as a third signal indicating a third level of required user involvement in operation of the vehicle (e.g., that the driver must be in control of the steering wheel immediately). Processor 310 may control the one or more notification devices 320(1)-320(N) to provide a visual notification in response to receiving the one or more signals indicating one or more levels of required user involvement in operation of the vehicle. Processor 310 may also control the one or more notification devices 320(1)-320(N) to adjust at least one aspect of the visual notification corresponding to a change in the respective level of required user involvement from one signal to another signal among the one or more signals. It is noteworthy that, although examples described herein refer to three different levels of required user involvement, a different number of levels of required user involvement in various implementations in accordance with the present disclosure.

In some embodiments, in controlling the one or more notification devices 320(1)-320(N) to provide the visual notification, processor 310 may be further configured to control the one or more notification devices 320(1)-320(N) to provide additional information pertaining to the respective level of required user involvement. The additional information may include, for example and not limited to, textual information, graphical information, audio information, video information, or any combination thereof. For example, the one or more notification devices 320(1)-320(N) may include a display device (e.g., a liquid crystal display panel, an electroluminescent panel or an organic LED display panel) configured to display textual, graphical and/or video information. In such cases processor 310 may control the display device to display a message to indicate the level of required user involvement in operation of the vehicle, in addition to the light emitted by one or more other notification devices (e.g., LED wire) of the one or more notification devices 320(1)-320(N). The message may, for example, indicate that vehicle control is being relinquished to the human driver.

In some embodiments, in controlling the one or more notification devices 320(1)-320(N) to adjust the at least one aspect of the visual notification corresponding to the change in the respective level of required user involvement, processor 310 may be configured to vary the at least one aspect of the visual notification according to the change in the respective level of required user involvement. For instance, in cases in which the visual notification includes an emitted light, the at least one aspect of the visual notification may include a color of the emitted light, an intensity of the emitted light, a frequency of flashing or blinking of the emitted light, or any combination thereof.

In some embodiments, in controlling the one or more notification devices 320(1)-320(N) to provide the visual notification, processor 310 may be configured to control the one or more notification devices 320(1)-320(N) to provide the visual notification in a first manner indicating that user attention is needed on a first side (e.g., right side) of the vehicle or in a second manner indicating that user attention is needed on a second side (e.g., left side) of the vehicle different from the first side of the vehicle. For example, processor 310 may control an LED wire of the one or more notification devices 320(1)-320(N) to emit a green light, whether steady and/or flashing/blinking, to indicate to the driver that it is safe to remove hands from the steering wheel. The LED wire may remain green regardless of whether the driver removes his/her hands from the steering wheel. Additionally, processor 310 may control the LED wire of the one or more notification devices 320(1)-320(N) to emit an orange light, whether steady and/or flashing/blinking, to indicate to the driver that the driver needs to take control of the steering wheel. Moreover, processor 310 may control the LED wire of the one or more notification devices 320(1)-320(N) to emit a red light, whether steady and/or flashing/blinking, to indicate to the driver that the driver must be in control of the steering wheel immediately. As another example, processor 310 may control a first light source of the one or more notification devices 320(1)-320(N) to emit light, whether steady and/or flashing/blinking, on the first side of the vehicle to indicate that user attention is needed on the first side of the vehicle, and may control a second light source of the one or more notification devices 320(1)-320(N) to emit light, whether steady and/or flashing/blinking, on the second side of the vehicle to indicate that user attention is needed on the second side of the vehicle.

In some embodiments, processor 310 may be further configured to control the one or more notification devices 320(1)-320(N) to provide an auditory notification with at least one aspect of the auditory notification corresponding to the respective level of required user involvement indicated by each signal of the one or more signals. For instance, processor 310 may be configured to vary the at least one aspect of the auditory notification according to a change in the respective level of required user involvement from one signal to another signal of the one or more signals. In cases in which the auditory notification includes an emitted sound, the at least one aspect of the auditory notification may include a tone of the emitted sound, a volume of the emitted sound, a pitch of the emitted sound, or any combination thereof.

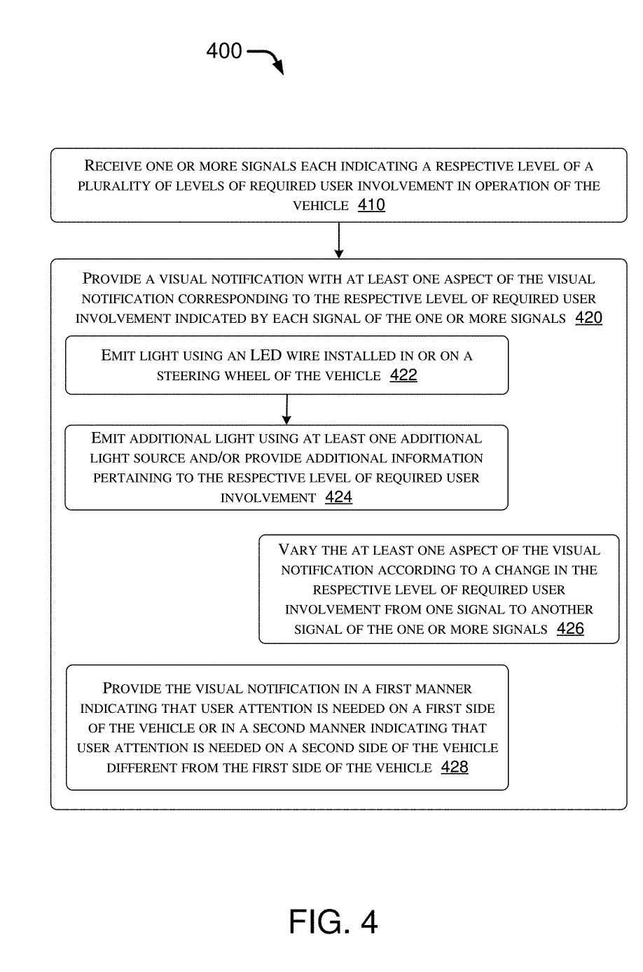

FIG. 4 illustrates an example process 400 in accordance with the present disclosure. Process 400 may include one or more operations, actions, or functions shown as blocks such as 410 and 420 as well as sub-blocks 422, 424, 426 and 428. Although illustrated as discrete blocks, various blocks of process 400 may be divided into additional blocks, combined into fewer blocks, or eliminated, depending on the desired implementation. Process 400 may be implemented by scenario 100, vehicle 200 and notification manager 300. For illustrative purposes and without limiting the scope of process 400, the following description of process 400 is provided in the context of scenario 100. Process 400 may begin with block 410.

At 410, process 400 may involve notification system 110 receiving one or more signals each indicating a respective level of multiple levels of required user involvement in operation of the vehicle. Process 400 may proceed from 410 to 420.

At 420, process 400 may involve notification system 110 providing a visual notification with at least one aspect of the visual notification corresponding to the respective level of required user involvement indicated by each signal of the one or more signals. In some embodiments, in providing a visual notification with at least one aspect of the visual notification corresponding to the respective level of required user involvement indicated by each signal of the one or more signals, process 400 may involve notification system 110 performing a number of operations, as shown in sub-blocks 422, 424, 426 and 428.

At 422, process 400 may involve notification system 110 providing of the visual notification comprises emitting light using an LED wire installed in or on a steering wheel of the vehicle. Process 400 may proceed from 422 to 424. At 424, process 400 may involve notification system 110 emitting additional light using at least one additional light source and/or providing additional information pertaining to the respective level of required user involvement. In some embodiments, the at least one additional light source may be installed in or on a display panel, a dashboard, a center console, a door panel, a cup holder, a door handle, a windshield, an overhead ceiling, or a visor of the vehicle. In some embodiments, the additional information may include textual information, graphical information, audio information, video information, or any combination thereof. Alternatively or additionally, at 426, process 400 may involve notification system 110 varying the at least one aspect of the visual notification according to a change in the respective level of required user involvement from one signal to another signal of the one or more signals. In some embodiments, the visual notification may include an emitted light, and wherein the at least one aspect of the visual notification comprises a color of the emitted light, an intensity of the emitted light, a frequency of flashing or blinking of the emitted light, or any combination thereof. Alternatively or additionally, at 428, process 400 may involve notification system 110 providing the visual notification in a first manner indicating that user attention is needed on a first side (e.g., left side) of the vehicle or in a second manner indicating that user attention is needed on a second side (e.g., right side) of the vehicle different from the first side of the vehicle.

In some embodiments, in addition to or in lieu of the visual notification, process 400 may involve notification system 110 providing an auditory notification with at least one aspect of the auditory notification corresponding to the respective level of required user involvement indicated by each signal of the one or more signals. In some embodiments, in providing the auditory notification with at least one aspect of the auditory notification corresponding to the respective level of required user involvement indicated by each signal of the one or more signals, process 400 may involve notification system 110 varying the at least one aspect of the auditory notification according to a change in the respective level of required user involvement from one signal to another signal of the one or more signals. In some embodiments, the auditory notification may include an emitted sound, and the at least one aspect of the auditory notification may include a tone of the emitted sound, a volume of the emitted sound, a pitch of the emitted sound, or any combination thereof

In the above disclosure, reference has been made to the accompanying drawings, which form a part hereof, and in which is shown by way of illustration specific implementations in which the present disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure.

What is claimed is:

1. A method, comprising:
receiving, by a notification system of a vehicle, one or more signals each indicating a respective level of a plurality of levels of required user involvement in operation of the vehicle;
providing, by the notification system, a visual notification with at least one aspect of the visual notification corresponding to the respective level of required user involvement indicated by each signal of the one or more signals; and
providing, by the notification system, an auditory notification with at least one aspect of the auditory notification corresponding to the respective level of required user involvement indicated by each signal of the one or more signals,
wherein the providing of the auditory notification with at least one aspect of the auditory notification corresponding to the respective level of required user involvement indicated by each signal of the one or more signals comprises varying the at least one aspect of the auditory notification according to a change in the respective level of required user involvement.

2. (canceled)

3. The method of claim 1, wherein the providing of the visual notification further comprises emitting additional light using at least one additional light source installed in or on a display panel, a dashboard, a center console, a door panel, a cup holder, a door handle, a windshield, an overhead ceiling, or a visor of the vehicle.

4. The method of claim 1, wherein the providing of the visual notification further comprises providing additional information pertaining to the respective level of required user involvement, and wherein the additional information comprises textual information, graphical information, audio information, video information, or any combination thereof.

5. The method of claim 1, wherein the providing of the visual notification with at least one aspect of the visual notification corresponding to the respective level of required user involvement indicated by each signal of the one or more signals comprises varying the at least one aspect of the visual notification according to a change in the respective level of required user involvement from one signal to another signal of the one or more signals.

6. The method of claim 5, wherein the visual notification comprises an emitted light, and wherein the at least one aspect of the visual notification comprises a color of the emitted light, an intensity of the emitted light, a frequency of flashing or blinking of the emitted light, or any combination thereof.

7. The method of claim 1, wherein the providing of the visual notification comprises providing the visual notification in a first manner indicating that user attention is needed on a first side of the vehicle or in a second manner indicating that user attention is needed on a second side of the vehicle different from the first side of the vehicle.

8. (canceled)

9. (canceled)

10. The method of claim 1, wherein the auditory notification comprises an emitted sound, and wherein the at least one aspect of the auditory notification comprises a tone of the emitted sound, a volume of the emitted sound, a pitch of the emitted sound, or any combination thereof.

11. An apparatus implementable in a vehicle, comprising:
at least one notification device; and
a processor operatively coupled to the at least one notification device, the processor configured to perform operations comprising:
receiving one or more signals each indicating a respective level of a plurality of levels of required user involvement in operation of the vehicle;
controlling the at least one notification device to provide a visual notification;
controlling the at least one notification device to adjust at least one aspect of the visual notification corresponding to a change in the respective level of required user involvement from one signal to another signal among the one or more signals; and
controlling the at least one notification device to provide an auditory notification with at least one aspect of the auditory notification corresponding to the respective level of required user involvement indicated by each signal of the one or more signals,
wherein, in providing the auditory notification with at least one aspect of the auditory notification corresponding to the respective level of required user involvement indicated by each signal of the one or more signals, the processor is configured to vary the at least one aspect of the auditory notification according to a change in the respective level of required user involvement.

12. (canceled)

13. The apparatus of claim 11, wherein the at least one notification device further comprises at least one additional light source installed in or on a display panel, a dashboard, a center console, a door panel, a cup holder, a door handle, a windshield, an overhead ceiling, or a visor of the vehicle.

14. The apparatus of claim 11, wherein, in controlling the at least one notification device to provide the visual notification, the processor is further configured to control the at least one notification device to provide additional information pertaining to the respective level of required user involvement, and wherein the additional information comprises textual information, graphical information, audio information, video information, or any combination thereof.

15. The apparatus of claim 11, wherein, in controlling the at least one notification device to adjust the at least one aspect of the visual notification corresponding to the change in the respective level of required user involvement, the processor is configured to vary the at least one aspect of the visual notification according to the change in the respective level of required user involvement.

16. The apparatus of claim 15, wherein the visual notification comprises an emitted light, and wherein the at least one aspect of the visual notification comprises a color of the emitted light, an intensity of the emitted light, a frequency of flashing or blinking of the emitted light, or any combination thereof.

17. The apparatus of claim 11, wherein, in controlling the at least one notification device to provide the visual notification, the processor is configured to control the at least one notification device to provide the visual notification in a first manner indicating that user attention is needed on a first side of the vehicle or in a second manner indicating that user attention is needed on a second side of the vehicle different from the first side of the vehicle.

18. (canceled)

19. (canceled)

20. The apparatus of claim 11, wherein the auditory notification comprises an emitted sound, and wherein the at least one aspect of the auditory notification comprises a tone of the emitted sound, a volume of the emitted sound, a pitch of the emitted sound, or any combination thereof.
